(19) United States
(12) Patent Application Publication
(10) Pub. No.: US 2002/0094167 A1
(43) Pub. Date: Jul. 18, 2002

(54) Dispersive optical waveguide array

(75) Inventors: Stephen Roberts, Winchester (GB); Gregory Pandraud, Kidlington (GB)

Correspondence Address: SUGHRUE MION ZINN MACPEAK & SEAS, PLLC, 2100 Pennsylvania Avenue, NW, Washington, DC, 20037-3213, US

(73) Assignee: BOOKHAM TECHNOLOGY plc

(21) Appl. No.: 09/963,495

(22) Filed: Sep. 27, 2001

(30) Foreign Application Priority Data
Sep. 27, 2000 (GB) 0023700.8

(51) Int. Cl. G02B 6/26; G02B 6/34; G02B 6/10

(52) U.S. Cl. 385/39; 385/15; 385/37; 385/129

(57) ABSTRACT

A dispersive optical waveguide device comprising an array of curved silicon rib waveguides providing optical paths in parallel between a first optical coupler at one end of the array and a second optical coupler at an opposite end of the array. The ends of the array waveguides adjacent to the second coupler are distributed around a first arcuate edge of the second coupler forming part of a first circle. A plurality of connecting waveguides terminating at a second arcuate edge of the second coupler face the first arcuate edge of the second coupler. The second arcuate edge forms part of a second circle having a radius of curvature which is half the radius of curvature of the first circle and has its perimeter coincident with the perimeter of the first circle adjacent the ends of the array waveguides.

The invention relates to a dispersive optical waveguide array and more particularly to such an array using silicon rib waveguides.

Dispersive optical arrays are known for use in multiplexers and demultiplexers and may comprises an array of optical waveguides of different pathlengths thereby introducing phase changes between optical signals transmitted through the different waveguides within the array. Such a system may comprise a plurality of waveguides each arranged around a curved path so as to introduce different optical pathlengths. Such devices may include optical couplers at the input and output ends of the array to allow serial connection of the array with input and output waveguides.

It is an object of the present invention to provide an improved system of coupling input and/or output waveguides through optical couplers at the ends of such a dispersive rib waveguide array.

The invention provides a dispersive optical waveguide device comprising an array of curved silicon rib waveguides providing optical paths in parallel between a first optical coupler at one end of the array and a second optical coupler at an opposite end of the array, the ends of the array waveguides adjacent said second coupler being distributed around a first arcuate edge of said second coupler forming part of a first circle, and a plurality of connecting waveguides terminating at a second arcuate edge of said second coupler facing said first arcuate edge of the second coupler, said second arcuate edge forming part of a second circle having a radius of curvature which is half the radius of curvature of the said first circle and having its perimeter coincident with the perimeter of the first circle adjacent the said ends of the array waveguides.

Preferably the said ends of the array waveguides are inclined to each other so as to focus at said second arcuate edge of the second coupler.

Preferably said connecting waveguides are inclined towards each other at said second arcuate edge so as to focus at said first arcuate edge of said second coupler.

Preferably said first optical coupler has two facing arcuate edges, one adjacent an end of the waveguide array forming part of a third circle and the other forming part of a fourth circle, the fourth circle having a radius of curvature one half that of the third circle and having its perimeter coincident with the perimeter of the third circle adjacent said array of waveguides.

Preferably an input waveguide is connected to the first optical coupler at the arcuate edge on said fourth circle facing said waveguide array.

Preferably said input waveguide is a silicon rib waveguide.

Preferably said first and third circles have the same radius of curvature.

Preferably said second and fourth circles have the same radius of curvature.

Preferably each of said first and second optical couplers comprise a slab region of silicon.

Preferably said connecting waveguides each comprise a silicon rib waveguide.

The waveguide device may be arranged to operate as a multiplexer or demultiplexer.

The waveguide device may comprise a single integrated silicon chip device.

An embodiment of the invention will now be described by way of example and with reference to the accompanying drawings in which:

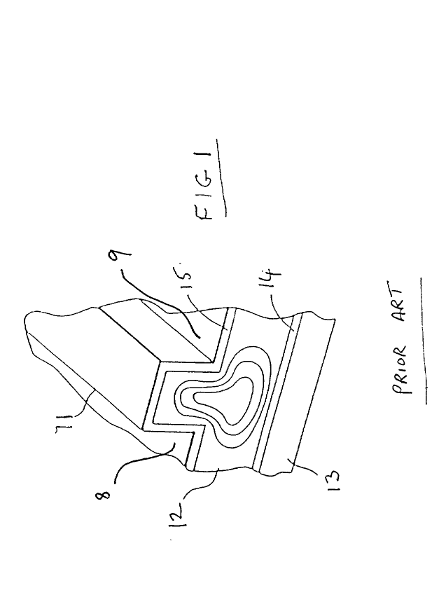

FIG. 1 shows a prior art construction of a silicon rib waveguide for use in accordance with this invention,

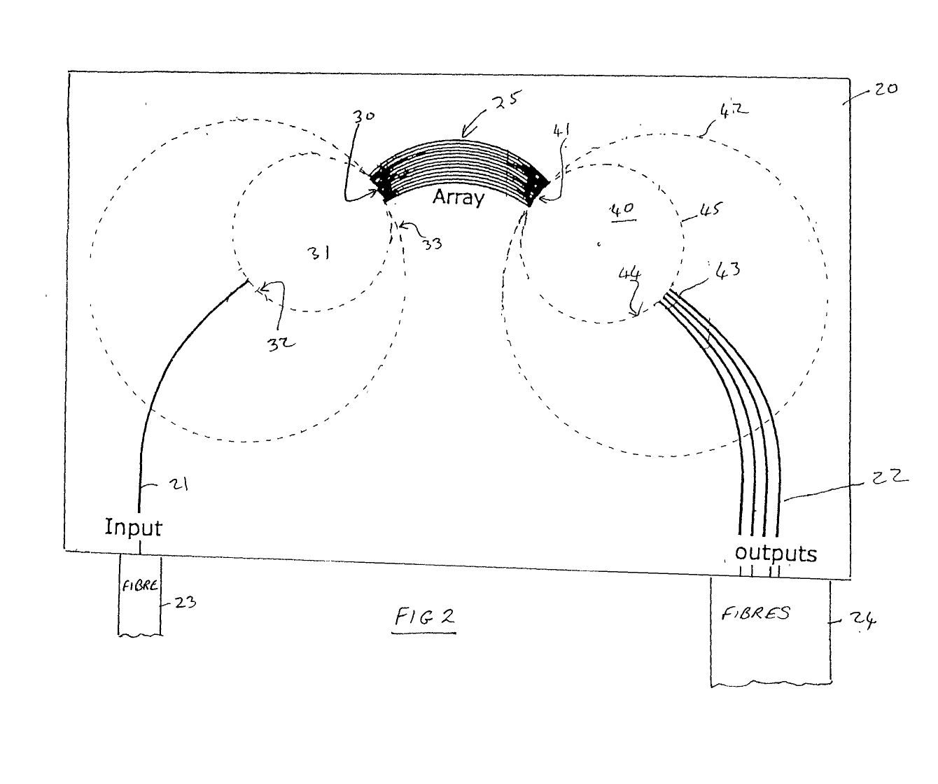

FIG. 2 is a schematic view of a dispersive waveguide array in accordance with the invention,

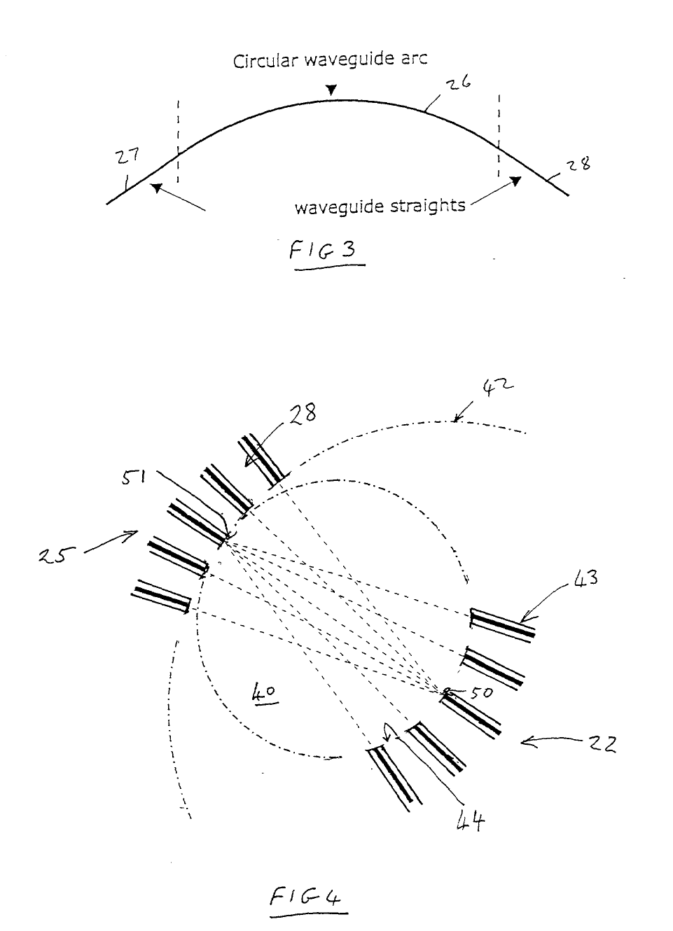

FIG. 3 shows in more detail one waveguide used in the array of FIG. 2, and

FIG. 4 shows in more detail the arrangement of waveguides in an optical coupler used in FIG. 2.

This embodiment comprises a single chip integrated silicon device having a plurality of silicon rib waveguides together with other optical circuitry. The structure of the silicon insulator rib waveguide is of known type and is shown in FIG. 1. The upstanding rib 11 is formed on a silicon layer 12. A silicon substrate 13 is covered with a silicon dioxide layer 14 immediately below the silicon layer 12. A silicon dioxide coating 15 is formed over the upper surface of the silicon and over the rib 11. The rib 11 may be formed by etching two trenches 8 and 9 along either side of the rib 11 in a slab of silicon so that the top of the rib is level with the remainder of unetched slab.

In the single chip embodiment of FIG. 2, a dispersive optical waveguide array is formed on a single integrated silicon chip 20. A plurality of waveguides including an input rib waveguide 21 and a plurality of output rib waveguides 22 are formed on the chip each having the construction shown in FIG. 1. The chip 20 provides a uniform thickness planar slab of silicon in which the rib waveguides are formed between elongated etched trenches on both sides of each rib. The input and output waveguides are connected to respective external optical fibres 23 and 24. On the silicon base 20 is formed an array 25 consisting of a plurality of similar rib waveguides each curved and providing optical paths in parallel with each curved waveguide lying side by side in the array. A single waveguide from the array is shown in more detail at 26 in FIG. 3. This has a central curved region terminating in a straight input end 27 and a straight output end 28. It will be understood that such dispersive arrays may be used as multiplexers or demultiplexers and consequently the direction of light may be changed such that the input and output positions are interchangeable. The input end 30 of the array has the straight portions 27 of each waveguide terminating along an arcuate surface of an optical coupler 31. The coupler 31 comprises unetched silicon slab having the same depth as the ribs of the rib waveguides. The etched trenches along opposite sides of each rib terminate at two facing arcuate edges of the coupler 31. The ends 30 of the array of waveguides terminate at one of the arcuate surfaces of the coupler marked 33 and the input waveguide 21 terminates on the opposite arcuate face of the coupler marked 32. The input waveguide 21 is arranged to be directed at the centre of the ends 30 of the waveguide array. The ends 30 of the waveguide array are themselves on the arcuate surface 33 which forms part of a circle of radius R. The facing arcuate surface 32 forms part of a circle of half the radius R but having its perimeter coincident with the arcuate surface 33 adjacent the ends 30 of the waveguide array. The straight ends 27 of the waveguide array 25 are inclined inwardly towards each other so as to focus at the end of the input waveguide 21 on the arcuate edge 32 of the coupler 31.

A similar optical coupler 40 is provided between the other end 41 of the array 25 and the output rib waveguides 22. The ends 41 of the array 25 are spaced around a first arcuate edge of the coupler 40, the arcuate edge forming part of a circle 42 having a radius R. The output waveguides 22 have their inner ends 43 terminating adjacent the further arcuate edge 44 forming part of a further circle 45 having a radius of one half R. The circle 45 has its periphery coincident with the arcuate edge of circle 42 adjacent the ends 41 of the waveguide array 25.

The straight ends 28 of the array 25 are again inwardly inclined towards each other so as to focus onto the perimeter of circle 45 adjacent the ends 43 of the output waveguides 22. Similarly the output waveguides 22 which are curved across the chip 20 have straight end portions 43 inclined towards each other so as to be focussed onto the perimeter of circle 42 immediately adjacent the ends 41 of the waveguides in the array 25.

It will be seen that the circular arrangement of the rib ends on the optical couplers 31 and 40 are similar at the input and output ends of the device so that its direction of use may be reversed. The arrangement of the circles 45 and 42 described in FIG. 2 is known as a Rowland circle arrangement.

In operation it is desirable that the wavefront leaving the output end of the dispersive array is focussed onto the or each output waveguide. Despite the physical separation between adjacent curved waveguides in the array 25, there will be some coupling of the wavefront towards the output end of the array due to the close physical proximity of adjacent waveguides. In the case of silicon rib waveguides the coupling of the wavefront between adjacent waveguides is much less than occurs with silica or with InP devices. The use of the Rowlands circle arrangement is such that the ends of the output waveguides 43 are located on the arc 44 which is much closer to the output ends 41 of the array than would be the case when using both arcs on a common circle. In cases where the output waveguides 43 join an optical coupler on an arc of the same circle 42 as the arc on which the array 25 terminates, much greater chip space is required. It will therefore be appreciated that in this example a Rowland circle arrangement the output waveguide 22 can be brought onto the arcuate surface 44 of a circle of only half the diameter thereby making the arrangement much more compact, although the coupling in the end regions of the dispersive array is weak.

The arrangement of the optical coupler 40 is shown in greater detail in FIG. 4 and illustrates the focussing of the waveguides 25 onto position 50 which is midway across the array of output waveguides 22. Similarly the output waveguides 22 are inclined inwardly so as to focus onto point 51 which is located midway across the array of waveguides 25. This figure shows the coupler region 40 as being part of the unetched silicon slab with each wave guide being formed as an unetched rib remaining between two trenches etched in the slab. The etched trenches terminate at the arcs 42 and 44 leaving the ribs running into the slab region forming the couplers 31 and 40.

The invention is not limited to the details of the foregoing example. For example, more than one input waveguide 21 may be provided.

1. A dispersive optical waveguide device comprising an array of curved silicon rib waveguides providing optical paths in parallel between a first optical coupler at one end of the array and a second optical coupler at an opposite end of the array, the ends of the array waveguides adjacent said second coupler being distributed around a first arcuate edge of said second coupler forming part of a first circle, and a plurality of connecting waveguides terminating at a second arcuate edge of said second coupler facing said first arcuate edge of the second coupler, said second arcuate edge forming part of a second circle having a radius of curvature which is half the radius of curvature of the said first circle and having its perimeter coincident with the perimeter of the first circle adjacent the said ends of the array waveguides.

2. A waveguide device according to claim 1 in which the said ends of the array waveguides are inclined to each other so as to focus at said second arcuate edge of the second coupler.

3. A waveguide device according to claim 1 or claim 2 in which said connecting waveguides are inclined towards-each other at said second arcuate edge so as to focus at said first arcuate edge of said second coupler.

4. A waveguide device according to any one of the preceding claims in which said first optical coupler has two facing arcuate edges, one adjacent an end of the waveguide array forming part of a third circle and the other forming part of a fourth circle, the fourth circle having a radius of curvature one half that of the third circle and having its perimeter coincident with the perimeter of the third circle adjacent said array of waveguides.

5. A waveguide device according to claim 4 in which an input waveguide is connected to the first optical coupler at the arcuate edge on said fourth circle facing said waveguide array.

6. A waveguide device according to claim 5 in which said input waveguide is a silicon rib waveguide.

7. A waveguide device according to any one of claims 4 to 6 in which said first and third circles have the same radius of curvature.

8. A waveguide device according to any one of claims 4 to 7 in which said second and fourth circles have the same radius of curvature.

9. A waveguide device according to any one of the preceding claims in which each of said first and second optical couplers comprise a slab region of silicon.

10. A waveguide device according to any one of the preceding claims in which said connecting waveguides each comprise a silicon rib waveguide.

11. A waveguide device according to any one of the preceding claims arranged to operate as a multiplexer or demultiplexer.

12. A waveguide device as claimed in any one of the preceding claims comprising a single integrated silicon chip device.

13. A waveguide device substantially as hereinbefore described with reference to and shown in the accompanying drawings.
